(19) United States
(12) Patent Application Publication
(10) Pub. No.: US 2010/0201604 A1
(43) Pub. Date: Aug. 12, 2010

(54) MULTI-FOLDABLE MOBILE DISPLAY APPARATUS

(75) Inventors: In-seo KEE, Seongnam-si (KR); Sung-hee LEE, Suwon-si (KR); Young-gu LEE, Suwon-si (KR); Hong-shik SHIM, Seoul (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); SAMSUNG MOBILE DISPLAY CO., LTD., Yongin-si (KR)

(21) Appl. No.: 12/702,360

(22) Filed: Feb. 9, 2010

(30) Foreign Application Priority Data
Feb. 12, 2009 (KR) 10-2009-0011502

(51) Int. Cl. G09G 5/00

(52) U.S. Cl. 345/1.3

(57) ABSTRACT

A multi-foldable mobile display apparatus includes a first display panel, a second display panel, and a third display panel which are successively disposed in an unfolded state of the multi-foldable mobile display apparatus, and a transparent plate disposed on the second display panel. The second display panel is disposed on a same side of both the first display panel and the third display panel, so that opposing edges of the second display panel respectively overlap the first display panel and the third display panel, in a plan view of the multi-foldable mobile display apparatus.

### CROSS-REFERENCE TO RELATED APPLICATIONS

This application claims priority to Korean Patent Application No. 10-2009-0011502, filed on Feb. 12, 2009, and all the benefits accruing therefrom under 35 U.S.C. §119, the disclosure of which is incorporated herein in its entirety by reference.

### BACKGROUND

1. Field

One or more embodiments relate to a multi-foldable mobile display apparatus including a plurality of display panels which are connected to each other to be foldable.

2. Description of the Related Art

Multi-foldable mobile display apparatuses are display apparatuses that are used to realize one large screen by connecting a plurality of display panels. For example, the multi-foldable mobile display apparatus may form a large screen by unfolding a plurality of unit display panels in series.

The multi-foldable display apparatus is a foldable display including a plurality of display panels connected to each other to realize a large screen of mobile devices such as mobile phones. Users of mobile devices may see desired images on a large screen formed of the multi-foldable display apparatuses.

Since the mobile devices are small, three or more display panels may be required in order to realize the large screen.

### SUMMARY

One or more embodiments include a multi-foldable mobile display apparatus providing images and having effectively no separation between a plurality of unfolded display devices.

Additional features will be set forth in part in the description which follows and, in part, will be apparent from the description, or may be learned by practice of the invention.

An exemplary embodiment includes a multi-foldable mobile display apparatus including a first display panel, a second display panel, and a third display panel which are successively disposed in an unfolded state of the multi-foldable mobile display apparatus, and a transparent plate on the second display panel. The second display panel is disposed under the first display panel and the third display panel, so that opposing edges of the second display panel respectively overlap the first display panel and the third display panel, in a plan view of the multi-foldable mobile display apparatus.

The transparent plate may be disposed overlapping a portion of both of the first display panel and the third display panel.

The transparent plate may be disposed adjacent to upper surfaces and lower surfaces of the first display panel and the third display panel, and disposed adjacent to sides of the first display panel and the third display panel facing the second display panel.

Each of the first to third display panels may include a display device disposed on a substrate, and a protective cover covering the display device, and the transparent plate may cover the protective cover.

Pixel boundaries of adjacent display devices which are successively arranged in the first to third display panels, may be arranged in corresponding vertical lines.

The transparent plate located on the second display panel may be about 0.001 millimeter (mm) to about 2 millimeters (mm) thicker than a thickness of the first display panel.

The transparent plate may have a refractive index of about 1.3 to about 1.7.

The transparent plate may include one material selected from polytetrafluoroethylene, a silicon resin, polymethyl methacrylate, and polydimethylsiloxane.

The multi-foldable mobile display apparatus may further include an optical film disposed on an upper surface of the transparent plate.

The optical film may be one of a polarization film, an anti-reflection (“AR”) film, and an anti-glare (“AG”) film.

The first to third display devices may include one of a liquid crystal display (“LCD”), a field emission display (“FED”), a plasma display panel (“PDP”), and an organic light-emitting diode (“OLED”).

An exemplary embodiment includes a multi-foldable mobile display apparatus including a first display panel, a second display panel, a third display panel, and a fourth display panel which are successively disposed in an unfolded state of the multi-foldable mobile display apparatus, and a transparent plate disposed on the second display panel and the fourth display panel. The second display panel is disposed under the first display panel and the third display panel so that opposing edges of the second display panel overlap portions of both the first display panel and the third display panel. The third display panel is disposed over the second display panel and the fourth display panel so that opposing edges of the third display panel overlaps portions of the second display panel and the fourth display panel, in a plan view of the multi-foldable mobile display apparatus.

An exemplary embodiment includes a multi-foldable mobile display apparatus including a plurality of a display panel which are arranged successively to be stepped with each other in an unfolded state of the multi-foldable mobile display apparatus, and a transparent plate which is disposed on the display panels which are lower than other display panels. The display panels are disposed to overlap neighboring display panels in a plan view of the multi-foldable mobile display apparatus.

The multi-foldable mobile display apparatus according to one or more embodiments may be unfolded to display images on a single large screen. In addition, there may be no separation between the display devices arranged in series, and a perpendicular stepped appearance resulting from the stepped space between the neighboring display panels may be reduced.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of an exemplary embodiment of a multi-foldable mobile display apparatus according to the invention;

FIG. 2 is a plan view of the multi-foldable mobile display apparatus illustrated in FIG. 1;

FIG. 3 is a cross-sectional view of the multi-foldable mobile display apparatus illustrated in FIG. 2;

FIG. 4 is a perspective view showing an exemplary embodiment of a folded state of the multi-foldable mobile display apparatus in FIG. 1;

FIG. 5 is a perspective view of another exemplary embodiment of a multi-foldable mobile display apparatus according to the invention;

FIG. 6 is a plan view of the multi-foldable mobile display apparatus illustrated in FIG. 5;

FIG. 7 is a cross-sectional view of the multi-foldable mobile display apparatus illustrated in FIG. 6; and

FIGS. 8 and 9 are perspective views showing an exemplary embodiment of a folded state of a four-layered display apparatus according to the invention.

### DETAILED DESCRIPTION

Reference will now be made in detail to embodiments, examples of which are illustrated in the accompanying drawings, wherein like reference numerals refer to the like elements throughout. In this regard, the exemplary embodiments may have different forms and should not be construed as being limited to the descriptions set forth herein. Accordingly, the embodiments are merely described below, by referring to the figures, to explain aspects of the present description.

Like numbers refer to like elements throughout. As used herein, the term “and/or” includes any and all combinations of one or more of the associated listed items. In the drawings, the size and relative sizes of layers and regions may be exaggerated for clarity.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower”, “under,” “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” or “over” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

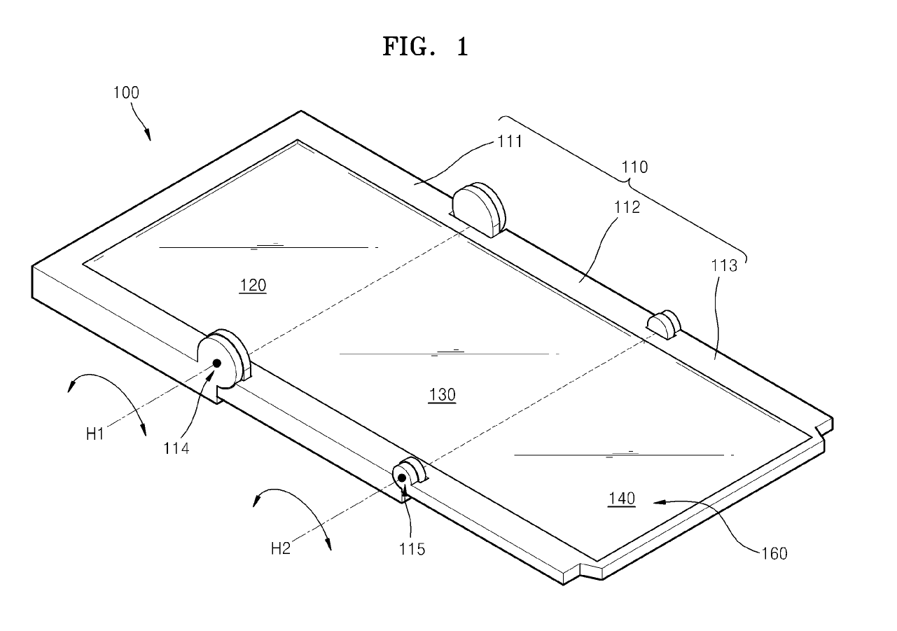

FIG. 1 is a perspective view of an exemplary embodiment a multi-foldable mobile display apparatus 100 according to the invention.

The multi-foldable display apparatus 100 includes a main body 110, and first to third display panels 120, 130, and 140, which are successively connected to the main body 110 to provide three display surfaces.

The main body 110 includes first to third portions 111, 112, and 113, which are respectively connected to the first to third display panels 120, 130, and 140. The first portion 111 and the second portion 112 may be folded toward each other around a first hinge axis H1, and the second portion 112 and the third portion 113 may be folded toward each other around a second hinge axis H2. The first hinge axis H1 and the second hinge axis H2 are respectively formed at hinge portions 114 and 115. A single unitary indivisible transparent plate 160 includes a soft material. An optical film (not shown) may be further adhered to the transparent plate 160.

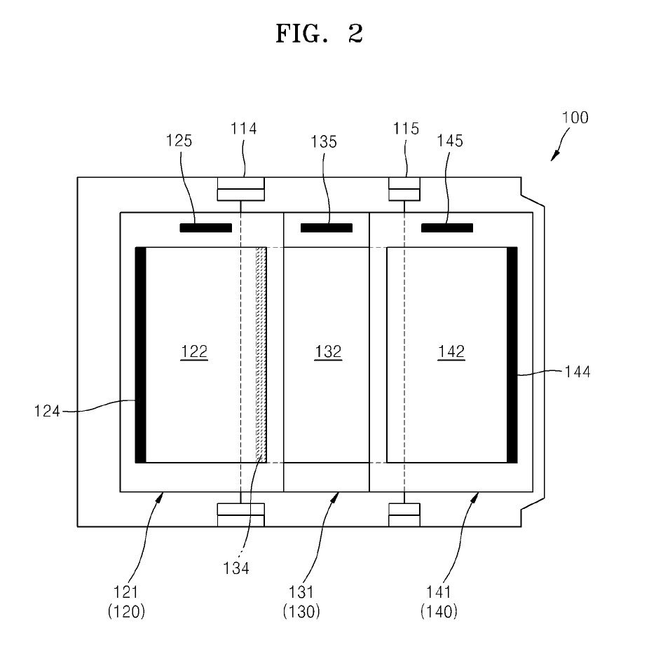

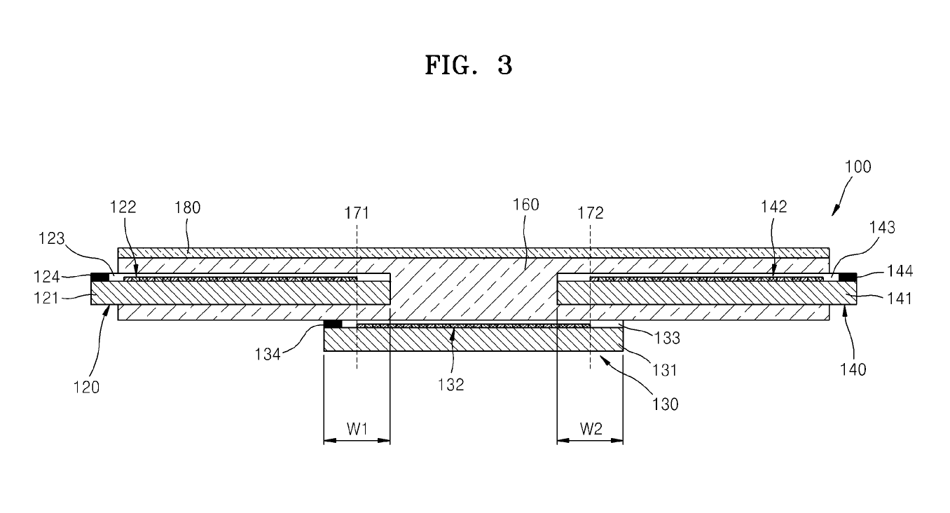

FIG. 2 is a plan view of the multi-foldable mobile display apparatus 100 illustrated in FIG. 1, and FIG. 3 is a cross-sectional view of the multi-foldable mobile display apparatus illustrated in FIG. 1. In FIG. 2, the transparent plate 160 and the optical film are not shown.

Referring to FIGS. 2 and 3, the first to third display panels 120, 130, and 140 respectively include first to third display devices 122, 132, and 142 disposed on first to third substrates 121, 131, and 141, and first to third protective covers 123, 133, and 143 respectively covering the first to third display devices 122, 132, and 142. The display devices 122, 132, and 142, which realize images on the display panels 120, 130, and 140 are illustrated in a simple way. In an exemplary embodiment, the display devices 122, 132, and 142 may include one of a liquid crystal display (“LCD”), a field emission display (“FED”), a plasma display panel (“PDP”), and an organic light-emitting diode (“OLED”).

The display panels 120, 130, and 140 are connected to each other to be foldable around the hinge axes H1 and H2 as shown in FIG. 1, and collectively form a single screen. The first display panel 120 is disposed overlapping the second display panel 130 in an unfolded state, and a portion of the first display panel 120 may overlap a portion of the second display panel 130. A pixel boundary of the first display device 122 and a pixel boundary of the second display device 132 are both arranged to align on a vertical line 171, and thus, the images displayed on the formed single screen may be continuous and unbroken at boundaries between the display devices 122 and 132 when the multi-foldable mobile display apparatus 100 is seen from an upper portion, otherwise referred to as a viewing side of the mobile display apparatus 100. The overlapping portions of the first display panel 120 and the third display panel 130 may each have a width W1 of about 4 millimeters (mm) or less.

The third display panel 140 is disposed overlapping the second display panel 130 in an unfolded state, and a portion of the third display panel 140 may overlap a portion of the second display panel 130. A pixel boundary of the third display device 142 and the pixel boundary of the second display device 132 are both arranged to align on a vertical line 172, and thus, the images may be displayed on the formed single screen without a separation when the multi-foldable mobile display apparatus 100 is seen from above. The overlapping portions of the second and third display panels 130 and 140 may each have a width W2 of 4 mm or less.

The multi-foldable mobile display apparatus 100 includes the transparent plate 160 which is disposed in a stepped space between the second display panel 130 and the first display panel 120, and the second display panel 130 and the third display panel 140, as illustrated in FIG. 3. The transparent plate 160 is disposed directly on and overlaps upper surfaces of both the first and third display panels 120 and 140 in order to compensate for vertical separation between the second display panel 130 and the first and third display panels 120 and 140, respectively.

The transparent plate 160 is disposed to surround the spaces between the second display panel 130 and the first and third display panels 120 and 140, respectively, so as to remove air gaps between the first and third display panels 120 and 140 and the transparent plate 160, respectively. As illustrated in FIG. 3, the transparent plate 160 is disposed overlapping a portion of a first (e.g., upper) surface and a portion of a second (e.g., lower) surface of both the first and third display panels 120 and 140, in addition to overlapping an entire of a third (e.g., side) surface adjacent to both the first and second surfaces of the first and third display panels 120 and 140.

An uppermost surface (e.g., at the viewing side of the multi-foldable mobile display apparatus 100) and a lowermost surface (e.g., at a rear side of the multi-foldable mobile display apparatus 100) of the transparent plate 160 are both a continuous planar surface. The transparent plate 160 is a single unitary indivisible member of the multi-foldable mobile display apparatus 100.

The transparent plate 160 overlapping each of the first, second and third display panels 120, 130 and 140, may be disposed on the second display panel 130 at the same height as that of the first and third display panels 120 and 140.

The transparent plate 160 may include a soft material that is flexible and elastic so as to be foldable when the display panels 120, 130, and 140 are disposed facing each other, respectively, in a folded configuration of the multi-foldable mobile display apparatus 100. In one exemplary embodiment, the transparent plate 160 may include one material selected from polymethyl methacrylate (“PMMA”), polydimethylsiloxane (“PDMS”), a transparent silicon resin, and polytetrafluoroethylene (“PTFE”) (otherwise known as Teflon® made by DuPont). When the transparent plate 160 is fabricated using the soft material, the display panels 120, 130, and 140 may be attached to each other due to elastic compression of the transparent plate 160.

The protective covers 123, 133, and 143 and the transparent plate 160 may have the same refractive indexes as each other so that light is not refracted at interfaces between the protective covers 123, 133, and 143 and the transparent plate 160. Where the refractive indexes of the protective covers 123, 133, and 143 and the transparent plate 160 are not the same as each other, the refractive indexes of the protective covers 123, 133, and 143 and the transparent plate 160 are substantially similar to each other so that the refraction of the light is rarely represented. In one exemplary embodiment, the refractive index of the transparent plate 160 may be in a range of about 1.3 to about 1.7. An appropriate additive may be included in the transparent plate 160 for adjusting the refractive index of the transparent plate 160.

Referring again to FIG. 3, an optical film 180 may be further disposed on an upper surface of the transparent plate 160 in order to improve the performance of the multi-foldable mobile display apparatus 100. The optical film 180 may be disposed directly on and overlap an entire of the upper surface of the transparent plate 160. In one exemplary embodiment, a polarization film, an anti-reflection (“AR”) film, and/or an anti-glare (“AG”) film may be attached to the entire upper surface of the transparent plate 160.

A thickness of the transparent plate 160 take in a direction substantially perpendicular to the upper surface of the transparent plate 160, may vary depending on a thickness of the first display panel 120 and the thickness of the third display panel 140. In one exemplary embodiment, the first display panel 120 may have a thickness of about 0.01 mm to about 3 mm, and the transparent plate 160 may have a thickness of about 0.001 mm to about 2 mm thicker than that of the first display panel 120. The thickness of the transparent plate 160 around (e.g., directly adjacent to surfaces of) the first display panel 120 may be about 0.001 mm to about 1 mm taken perpendicular from the upper surface or the lower surface of the first display panel 120, respectively. The thickness of the transparent plate 160 around (e.g., directly adjacent to surfaces of) the second display panel 130 may be about 0.012 mm to about 5 mm taken perpendicular from the upper surface of the second display panel 130.

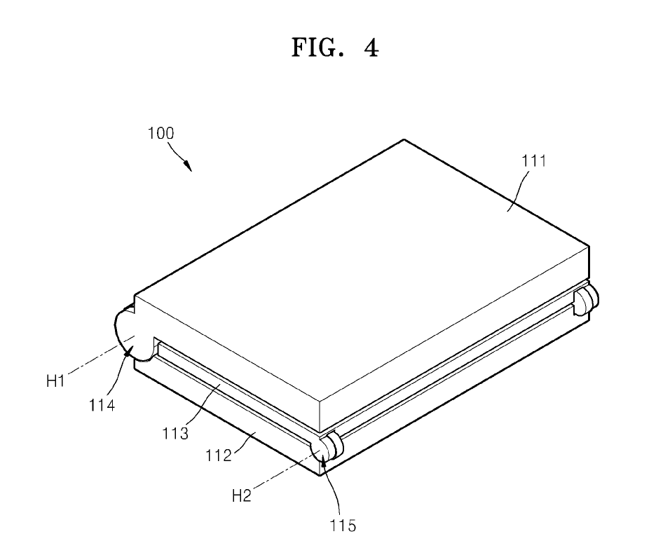

FIG. 4 is a perspective view of an exemplary embodiment of a folded state of the three-layered display apparatus according to the invention.

Referring to FIG. 4, the multi-foldable mobile display apparatus 100 is folded, such that the third display panel 140 is disposed on and facing the second display panel 130, around the second hinge axis H2 The first display panel 120 is disposed on and facing the second display panel 130 around the first hinge axis H1 when the multi-foldable mobile display apparatus 100 is folded. The second hinge axis H2 may be located on (e.g., substantially coplanar with) the upper surface of the transparent plate 160, and the first hinge axis H1 may be located higher and further from the upper surface of the transparent plate 160 than the second hinge axis H2, such as being located higher by as much as the thickness of the third display panel 140. Since the transparent plate 160 includes the soft material, the multi-foldable mobile display apparatus 100, including the two display panels 120 and 140, may be folded easily.

Even when the width W1 is a few mm greater than the thickness of the transparent plate 160 between the third display panel 140 and the second display panel 130, since the second hinge axis H2 is located on the upper surface of the transparent plate 160 or above the transparent plate 160 and the transparent plate 160 is flexible, the third display panel 140 can be rotated without contacting the second display panel 130 when the third display panel 140 is rotated around the second hinge axis H2. In addition, when the first display panel 120 is rotated around the first hinge axis H1 toward the third display panel 140 which is previously disposed on the second display panel 130, the first display panel 120 can be rotated so that an end portion of the first display panel 120 does not contact the second display panel 130 since the height of the first hinge axis H1 is equal to that of the third display panel 140 or greater.

Referring to FIGS. 2 and 3, scan line drivers 124, 134, and 144 and data line drivers 125, 135, and 145 which respectively drive the display devices 122, 132, and 142 may be disposed on sides or adjacent to edges of the display devices 122, 132, and 142. Left and right sides of the second display device 132 are covered (e.g, overlapped) by the first and third display devices 122 and 142, and the scan line driver 134 and the data line driver 135 may be disposed on each of four side edges of the second display device 132, respectively. In FIGS. 2 and 3, the scan line driver 134 of the second display device 132 is installed on the left side of the second display device 132, and the data line driver 135 is installed on the upper portion of the second display panel 130, in the plan view of the multi-foldable mobile display apparatus 100.

The scan line drivers 124 and 144 of the first and third display devices 122 and 142 may be respectively disposed on a left side of the first display device 122 and a right side of the third display device 142 so as not to cover the second display device 132. The data line drivers 125 and 145 may both be disposed on the upper portions or lower portions of the corresponding display panels 120 and 140. In the illustrated embodiment of FIG. 2, the data line drivers 125 and 145 are both disposed on the upper portions of the corresponding display panels 120 and 140.

The multi-foldable mobile display apparatus 100 of the illustrated exemplary embodiment may be formed to have a small size, and if necessary, the multi-foldable mobile display apparatus 100 may be unfolded to display the images on a single, and effectively continuous, large screen. In addition, the multi-foldable mobile display apparatus 100 may show no separation between the display devices 122, 132, and 142, and a perpendicular stepped appearance resulting from the stepped space between the neighboring display panels may be reduced.

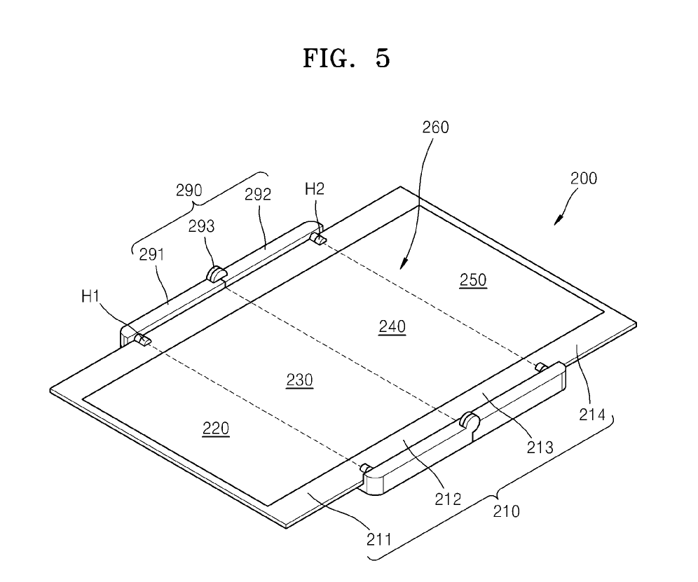

FIG. 5 is a perspective view of another exemplary embodiment of a multi-foldable mobile display apparatus 200 according to the invention.

The multi-foldable mobile display apparatus 200 includes a main body 210, first to fourth display panels 220, 230, 240, and 250, which are successively connected to the main body 210 to provide four display surfaces, and a folder 290.

The main body 210 includes first to fourth portions 211, 212, 213, and 214, which are respectively connected to the first to fourth display panels 220, 230, 240, and 250. The first and second portions 211 and 212 may be disposed facing each other when the multi-foldable mobile display apparatus 200 is folded at a first hinge H1, and the third and fourth portions 213 and 214 may be disposed facing each other when the multi-foldable mobile display apparatus 200 is folded at a second hinge H2.

The folder 290 includes a first member 291, a second member 292, and a hinge portion 293. The first member 291 is coupled to the second display panel 230, and the second member 292 is coupled to the third display panel 240. The first member 291 may also be connected to a portion of the first display panel 220, and the second member 292 may also be connected to a portion of the fourth display panel 250. The first and second members 291 and 292 may be moved toward each other around the hinge portion 293 when the multi-foldable mobile display apparatus 200 is folded.

A transparent plate 260 includes a soft material.

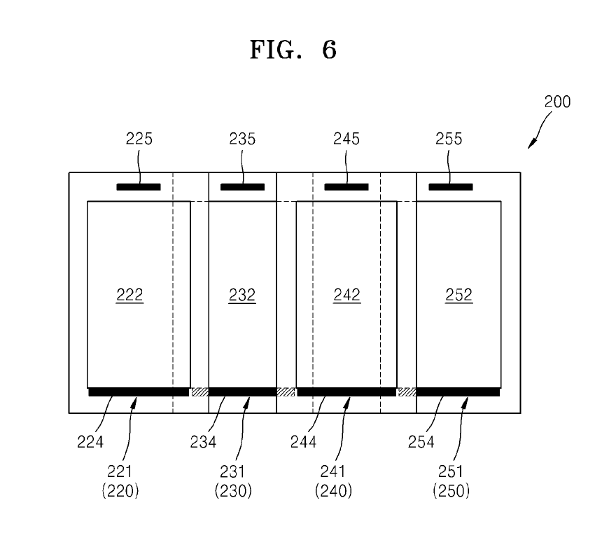

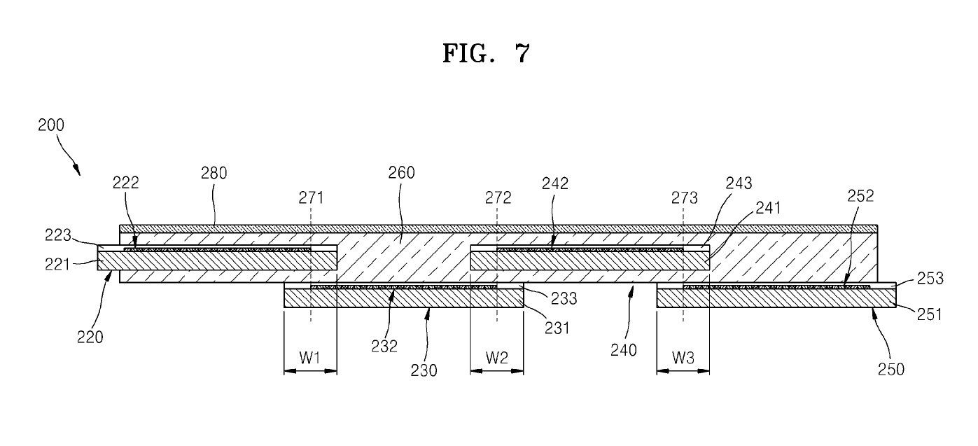

FIG. 6 is a plan view of the multi-foldable mobile display apparatus 200 illustrated in FIG. 5, and FIG. 7 is a cross-sectional view of the multi-foldable mobile display apparatus 200 illustrated in FIG. 6.

Referring to FIGS. 6 and 7, the first to fourth display panels 220, 230, 240, and 250 respectively include first to fourth display devices 222, 232, 242, and 252 which are respectively disposed on first to fourth substrates 221, 231, 241, and 251 and first to fourth protective covers 223, 233, 243, and 253 which respectively cover the first to fourth display devices 222, 232, 242, and 252. The display devices 222, 232, 242, and 252 realizing images on the display panels 220, 230, 240, and 250 are illustrated briefly. In an exemplary embodiment, the display devices 222, 232, 242, and 252 may be one of an LCD, an FED, a PDP, and an OLED.

The first display panel 220 is disposed above the second display panel 230 (e.g., towards a viewing side) in an unfolded state of the multi-foldable mobile display apparatus 200, and a portion of the first display panel 220 may overlap a portion of the second display panel 230. The first and second display panels 220 and 230 may be arranged so that a side of the first display device 222 and a side of the second display device 232 are aligned and disposed on a same vertical line 271, and thus, a screen of the multi-foldable mobile display apparatus 200 may be continuous and unbroken when the multi-foldable mobile display apparatus 200 is seen from above. A width W1 of the overlapping portions of the first and second display panels 220 and 230 may be about 4 mm or less.

The third display panel 240 is disposed above the second and fourth display panels 230 and 250 in the unfolded state of the multi-foldable mobile display apparatus 200. In addition, a portion of the left side of the third display panel 240 may overlap a portion of the second display panel 230, and a portion of the right side of the third display panel 240 may overlap a portion of the fourth display panel 250. The second to fourth display panels 230, 240, and 250 are arranged so that a left side of the third display device 242 and a right side of the second display device 232 may be aligned and disposed on a same vertical line 272, and a right side of the third display device 242 and a left side of the fourth display device 252 are aligned and disposed on same vertical line 273. Therefore, the screen of the multi-foldable mobile display apparatus 200 may be continuous and unbroken when the multi-foldable mobile display apparatus 200 is seen from above. Widths W2 and W3 of the overlapping portions may be about 4 mm or less.

In order to compensate for vertical separations between the display panels 220, 230, 240, and 250, the multi-foldable mobile display apparatus 200 includes portions of the transparent plate 260 overlapping the second and fourth display panels 230 and 250 which fill spaces between the first to fourth display panels 220, 230, 240, and 250, respectively. Portions of the transparent plate 260 also directly contact and cover upper surfaces of the first and third display panels 220 and 240. The transparent plate 260 is additionally disposed at sides of the first and third display panels 220 and 240 to surround the upper and lower surfaces of the first and third display panels 220 and 240 so as to remove air gaps between the transparent plate 260 and the display panels 220, 230, 240, and 250.

An uppermost surface (e.g., at the viewing side of the multi-foldable mobile display apparatus 200) and a lowermost surface (e.g., at a rear side of the multi-foldable mobile display apparatus 200) of the transparent plate 260 are both a continuous planar surface. The transparent plate 260 is a single unitary indivisible member of the multi-foldable mobile display apparatus 200.

Portions of the transparent plate 260 overlapping only the second and fourth display panels 230 and 250 may be disposed at the same height as those portions overlapping of the first and third display panels 220 and 240.

The transparent plate 260 may include a soft material which is flexible and elastic so as to be bent when the display panels 220, 230, 240, and 250 are disposed to face each other when the multi-foldable mobile display apparatus 200 is folded. In one exemplary embodiment, the transparent plate 260 may include one material selected from PMMA, PDMS, a transparent silicon resin, and Teflon®. When the transparent plate 260 includes the soft material, the display panels 220, 230, 240, and 250 may be attached to each other due to elastic compression of the transparent plate 260.

The protective covers 223, 233, 243, and 253 and the transparent plate 260 may have the same refractive indexes as each other so that light is not refracted at interfaces between the protective covers 223, 233, 243, and 253 and the transparent plate 260. Where the refractive indexes of the protective covers 223, 233, 243, and 253 and the transparent plate 260 are not the same as each other, the refractive indexes of the protective covers 223, 233, 243, and 253 and the transparent plate 260 are substantially similar to each other so that the refraction of the light is rarely represented. In one exemplary embodiment, the refractive index of the transparent plate 260 may be in a range of about 1.3 to about 1.7. An appropriate additive may be included in the transparent plate 260 for adjusting the refractive index of the transparent plate 260.

An optical film 280 may be further disposed on an upper surface of the transparent plate 260 in order to improve the performance of the multi-foldable mobile display apparatus 200 according to usage of the multi-foldable display apparatus 200. In one exemplary embodiment, a polarization film, an anti-reflection (“AR”) film, and/or an anti-glare (“AG”) film may be attached to the entire upper surface of the transparent plate 260.

A thickness of the transparent plate 260 taken in a direction substantially perpendicular to the upper surface of the transparent plate 260, may vary depending on the thickness of the first display panel 220 and the thickness of the third display panel 240. In one exemplary embodiment, the first display panel 220 may have a thickness of about 0.01 mm to about 3 mm, and the transparent plate 260 may be disposed to have a thickness that is about 0.001 mm to about 2 mm thicker than that of the first display panel 220. The thickness of the transparent plate 260 around (e.g., adjacent to) the first display panel 220 may be about 0.001 mm to about 1 mm taken from the upper surface or the lower surface of the first display panel 220, and the thickness of the transparent plate 260 around the second display panel 230 (e.g., between the first and second display panel 220 and 230) may be about 0.012 mm to about 5 mm from the upper surface of the second display panel 230.

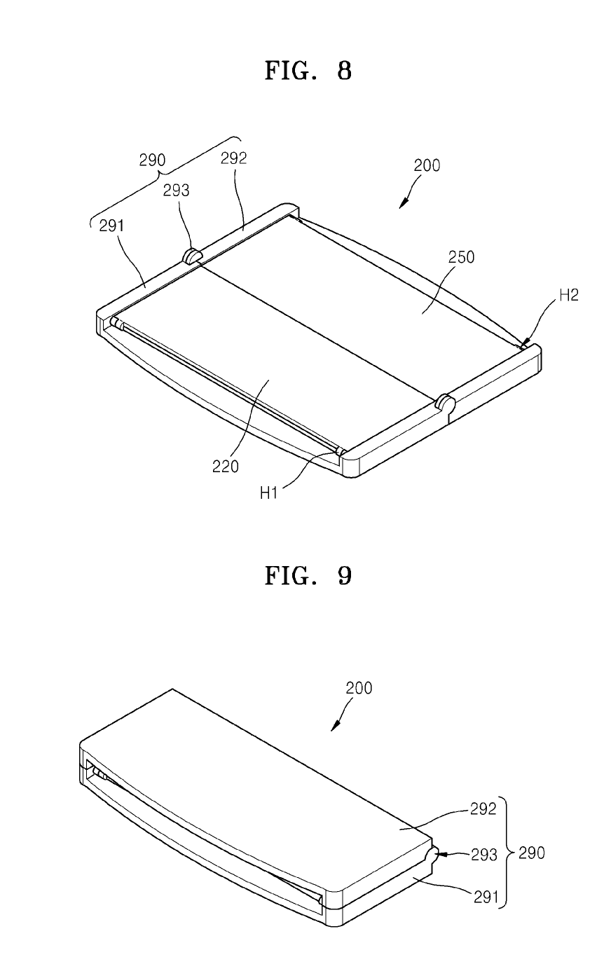

FIGS. 8 and 9 are perspective views of an exemplary embodiment of a folded state of the four-layered multi-foldable mobile display apparatus 200 according to the invention.

FIG. 8 shows a state where the first display panel 220 is moved around the first hinge H1 toward the second display panel 230, and the fourth display panel 250 is moved around the second hinge H2 toward the third display panel 240. Hinge axes corresponding to the first and second hinges H1 and H2 may be located on the upper surface of the transparent plate 260 shown in FIG. 5.

FIG. 9 shows that the first member 291 and the second member 292 are moved around the hinge portion 293 toward each other. In FIG. 5, an axis of the hinge portion 293 is located higher than axes of the first and second hinges H1 and H2, and disposed further from the upper surface of the transparent plate 260 than the first and second hinges H1 and H2. The axis of the hinge portion 293 may be located higher than the axes of the hinges H1 and H2 by as much as the thickness of the first display panel 220. Since the transparent plate 260 includes the soft material, the second and third display panels 230 and 240 may overlap each other easily when the first and second members 291 and 292 are moved toward each other when the multi-foldable mobile display apparatus 200 is folded.

Referring to FIG. 6, scan line drivers 224, 234, 244, and 254 and data line drivers 225, 235, 245, and 255 for driving the display devices 222, 232, 242, and 252 may be disposed on upper and lower portions of the display panels 220, 230, 240, and 250, respectively, in the plan view of the multi-foldable mobile display apparatus 200.

In addition, although it is not shown in FIG. 6, the scan line driver 224 of the first display device 222 may be disposed on a left side of the first display device 222, and the scan line driver 234 of the second display device 232 may be disposed on a left side or a right side of the second display device 232. The scan line driver 254 may be disposed on a right side of the fourth display device 252.

The multi-foldable mobile display apparatus 200 according to the illustrated embodiment may be formed to have a small size, and if necessary, the multi-foldable mobile display apparatus 200 may be unfolded to display images on a single, and effectively continuous large screen. In addition, the multi-foldable mobile display apparatus 200 may show no separation between the display devices 222, 232, 242, and 252, and a perpendicular stepped appearance resulting from the stepped space between the neighboring display panels may be reduced.

It should be understood that the exemplary embodiments described herein should be considered in a descriptive sense only and not for purposes of limitation. Descriptions of features within each embodiment should typically be considered as available for other similar features in other embodiments.

What is claimed is:

1. A multi-foldable mobile display apparatus comprising:
a first display panel, a second display panel, and a third display panel which are successively disposed in an unfolded state of the multi-foldable mobile display apparatus; and
a single unitary indivisible transparent plate disposed on the second display panel,
wherein the second display panel is disposed on a same side of both the first display panel and the third display panel, so that opposing edges of the second display panel respectively overlap a portion of both the first display panel and the third display panel in a plan view of the multi-foldable mobile display.

2. The multi-foldable mobile display apparatus of claim 1, wherein the transparent plate overlaps both a portion of the first display panel and a portion of the third display panel.

3. The multi-foldable mobile display apparatus of claim 2, wherein the transparent plate is disposed adjacent to upper surfaces and lower surfaces of the first display panel and the third display panel, and disposed adjacent to sides of the first display panel and the third display panel facing the second display panel.

4. The multi-foldable mobile display apparatus of claim 3, wherein each of the first to third display panels includes a display device disposed on a substrate, and a protective cover covering the display device,
wherein the transparent plate overlaps the protective cover.

5. The multi-foldable mobile display apparatus of claim 4, wherein pixel boundaries of adjacent display devices which are successively arranged in the first to third display panels, are aligned in corresponding vertical lines.

6. The multi-foldable mobile display apparatus of claim 5, wherein a portion of the transparent plate overlapping only the second display panel is about 0.001 millimeter to about 2 millimeter thicker than a thickness of the first display panel, the thicknesses taken perpendicular to the upper surface of the second display panel.

7. The multi-foldable mobile display apparatus of claim 3, wherein the transparent plate has a refractive index of about 1.3 to about 1.7.

8. The multi-foldable mobile display apparatus of claim 3, wherein the transparent plate includes one material selected from polytetrafluoroethylene, a silicon resin, polymethyl methacrylate, and polydimethylsiloxane.

9. The multi-foldable mobile display apparatus of claim 3, further comprising an optical film on an upper surface of the transparent plate.

10. The multi-foldable mobile display apparatus of claim 9, wherein the optical film is one of a polarization film, an anti-reflection film, and an anti-glare film.

11. A multi-foldable mobile display apparatus comprising:
a first display panel, a second display panel, a third display panel, and a fourth display panel which are successively disposed in an unfolded state of the multi-foldable mobile display apparatus; and
a single unitary indivisible transparent plate disposed on the second display panel and the fourth display panel,
wherein
the second display panel is disposed on a same first side of both the first display panel and the third display panel, so that opposing edges of the second display panel respectively overlap a portion of both the first display panel and the third display panel in a plan view of the multi-foldable mobile display apparatus, and
the third display panel is disposed on a same second side of both the second display panel and the fourth display panel, so that opposing edges of the third display panel respectively overlap a portion of both the second display panel and the fourth display panel in a plan view of the multi-foldable mobile display apparatus.

12. The multi-foldable mobile display apparatus of claim 11, wherein the transparent plate overlaps a portion of both the first and third display panels.

13. The multi-foldable mobile display apparatus of claim 12, wherein the transparent plate is disposed adjacent to upper surfaces and lower surfaces of the first display panel and the third display panel, disposed between sides of the first display panel and the third display panel facing the second display panel, and disposed adjacent to a side of the third display panel facing the fourth display panel.

14. The multi-foldable mobile display apparatus of claim 13, wherein each of the first to fourth display panels includes a display device disposed on a substrate, and a protective cover covering the display device,
wherein the transparent plate overlaps the protective cover.

15. The multi-foldable mobile display apparatus of claim 14, wherein in the first to fourth display panels, pixel boundaries of adjacent display devices which are successively arranged, are aligned in corresponding vertical lines.

16. The multi-foldable mobile display apparatus of claim 14, wherein the transparent plate overlapping only the second display panel is about 0.001 millimeter to about 2 millimeter thicker than a thickness of the first display panel, the thicknesses taken perpendicular to the upper surface of the second display panel.

17. The multi-foldable mobile display apparatus of claim 13, wherein the transparent plate has a refractive index of about 1.3 to about 1.7.

18. The multi-foldable mobile display apparatus of claim 13, wherein the transparent plate includes one material selected from polytetrafluoroethylene, a silicon resin, polymethyl methacrylate, and polydimethylsiloxane.

19. The multi-foldable mobile display apparatus of claim 13, further comprising an optical film on an upper surface of the transparent plate.

20. A multi-foldable mobile display apparatus comprising:
a plurality of a display panel which is arranged successively, such that adjacent display panels are disposed non-coplanar with each other in an unfolded state of the multi-foldable mobile display apparatus; and
a single unitary indivisible transparent plate which is disposed on the display panels which are disposed in a lower plane than the adjacent display panels,
wherein the display panels are disposed to overlap a portion of an adjacent display panel in a plan view of the multi-foldable mobile display apparatus.
